(19) United States
(12) Patent Application Publication
(10) Pub. No.: US 2022/0086530 A1
(43) Pub. Date: Mar. 17, 2022

(54) Data Entry Apparatus and Method

(71) Applicants: Saj Muzaffar, London (GB); Awais Muzaffar, London (GB)

(72) Inventors: Saj Muzaffar, London (GB); Awais Muzaffar, London (GB)

(21) Appl. No.: 17/030,534

(22) Filed: Sep. 24, 2020

(30) Foreign Application Priority Data
Sep. 11, 2020 (GB) 2014295.6

(51) Int. Cl. H04N 21/482

(52) U.S. Cl. CPC H04N 21/4828; H04N 21/4823; H04N 21/4826

(57) ABSTRACT

A data entry apparatus for e.g. a smart TV comprises a wireless remote control device which is used to navigate a series of cells (19) displayed on screen and containing possible alphanumeric characters at the nth position of a title of e.g. a movie or TV channel. Instead of displaying (say) all 26 letters of the alphabet in these cells, only the possible characters at the nth position of a stored list or dictionary of possible titles are displayed. They are displayed in descending frequency order (most common at the left). The process is repeated (steps S1 to S4) to build up a string of characters in a window (18) until a particular title is selected (YES branch from step S4) by selecting its associated image (20). The navigational effort required of the user is reduced.

### CROSS-REFERENCE TO RELATED APPLICATIONS

This application claims This application claims priority to United Kingdom Patent Application Number GB2014295.6, filed Sep. 11, 2020, the disclosure of which is incorporated by reference in its entirety.

### FIELD

The present invention relates to a data entry apparatus and method and relates particularly but not exclusively to such an apparatus and method including or implemented with a remote control device.

### BACKGROUND

Typically, such a remote control device will be used with video player/receiver such as a smart TV or a set-top box connected to a conventional TV or a cable or satellite TV for example. Apparatus of this type is disclosed in US 2012/246240A (Apple® Inc) for example. Such a remote control device can also be used with a video gaming apparatus, for example. Such a remote control device typically uses an IR or Bluetooth transmitter to send control signals to an IR or Bluetooth receiver, the received signals being decoded and used to select TV channels, video tracks, music tracks or websites for example.

The data entry apparatus and method of the invention are also usable with Augmented reality (AR) wearable apparatus (eyewear) wherein the remote control device is a smart-phone which the user inputs the data by means of the smartphone's touch screen, motion, keyboard or a combination thereof. The data entry apparatus and method of the invention are also usable with virtual reality (VR) apparatus in which the movements of the user are detected and used for controlling an immersive 3D visual effect e.g. with a wearable stereoscopic video display.

In view of the diversity and sophistication of the above types of apparatus, there has been a tendency to simplify the keyboards of such remote control devices in order to appeal to consumers. For example, the current Apple® TV remote control device has only five keys plus a touch surface, which are used for selecting menu items on screen, playing and pausing video, selecting the option of voice control, and controlling volume.

Although such remote controls are generally easy to use, they lack alphanumeric keys. To enter text, e.g. for selecting the name of a TV channel or a movie, it is necessary to use a cursor-movement key of the remote control to move a cursor to successive alphanumeric characters of the channel or movie name. The alphanumeric characters to be selected are typically displayed in a row of e.g. 26 characters on the screen of the smart TV or the like. Successive selections from these can be time-consuming.

An object of the present invention is to address the above technical problem in the user interface.

### SUMMARY

In one aspect the invention provides data entry apparatus for selecting, as a control output, a string of N alphanumeric characters from a group of such strings, N being an integer of two or greater, the apparatus including a) a display arranged to display alphanumeric characters to a user, and b) a selector operable by the user for selecting a displayed alphanumeric character, the display being arranged to display n sets of user-selectable alphanumeric characters in succession (n being an integer of two or greater such that n≤N), an alphanumeric character of the nth set being selectable to obtain the alphanumeric character in the nth position of a string, the nth set omitting alphanumeric characters which are not present at the nth position of any of the strings in said group for at least some values of n.

Because the nth set of user-selectable alphanumeric characters only includes the potentially relevant characters (i.e. those which could appear in an nth position of the name of a TV channel or a movie) rather than (say) all 26 letters of the alphabet, the cursor movement required at each stage is much less and the selection can be made significantly more quickly.

In certain embodiments the apparatus further comprises a memory in which said group of strings of alphanumeric characters is stored. in other embodiments the strings of alphanumeric characters are retrieved from a remote location via a communications link, e.g. over the Internet.

Typically said strings of alphanumeric characters in said group comprise words appearing in a dictionary. In such a case, the nth set of alphanumeric characters preferably excludes at least some strings of characters which are not words appearing in the dictionary. Not all such strings of characters will necessarily be excluded, since some strings available for selection, e.g. “channel4” or “ITV” may include combinations not found in a conventional dictionary.

Preferably said display is arranged to display more commonly occurring alphanumeric characters in a manner which makes them more easily selectable by the user than less commonly occurring alphanumeric characters. For example, in English, the twelve most commonly occurring letters, from most common to least common, are generally considered to be etaoin shrdlu. However the relative frequency, particularly for the less commonly used letter, varies somewhat with context and may be different for a relatively small sample of channel names or movie titles, for example. It may therefore be advantageous to determine the character frequency distribution empirically in some cases.

Preferably, the display is arranged to display more commonly occurring alphanumeric characters closer to a home position. This feature minimizes cursor movement from the home position (typically the left end of a row) and therefore speeds up the selection by the user.

Preferably, the display is arranged to display a image associated with a sequence of two or more alphanumeric characters in response to the selection of a sequence of alphanumeric characters commonly associated with that image.

The user can then move the cursor to select the image to complete the selection process. For example the image may be the logo of a TV channel whose name includes the sequence, or the image may be associated with a movie, e.g. because it appears in the advertising for that movie or on the cover or packaging of a recording medium (such as a DVD for example) on which the movie is recorded. Preferably, the selector operable by the user for selecting a displayed alphanumeric character comprises a pointing device.

In one embodiment the pointing device comprises one or more cursor-movement keys, e.g. arrow keys. Preferably the apparatus comprises a video player or video receiver arranged to display video on said display, said control output selecting a video stream to be played by the video player or received by said video receiver. In the embodiments described above the display is preferably a screen.

In certain embodiments the apparatus is a gaming apparatus, the gaming apparatus including a communications link to a remote gaming apparatus or server and further including a means for transmitting said control output signal over said communications link.

In such embodiments the display will typically be a wearable display. For example, the wearable display may optionally be part of a VR (virtual reality) headset.

In another aspect the invention provides a method of selecting a string of N alphanumeric characters from a group of such strings, N being an integer of two or greater, the method including a) displaying to a user n sets of alphanumeric characters in succession (n being an integer of two or greater such that n≤N), and b) the user selecting a displayed alphanumeric character of each set, an alphanumeric character of the nth set being the alphanumeric character in the nth position of a string, wherein the nth set omits alphanumeric characters which are not present at the nth position of any of the strings in said group for at least some values of n.

The invention also provides a computer program product for operating the data entry apparatus as defined above or for implementing the method as defined above, said computer program product comprising a computer-readable medium embodying program code means executable to control said data entry apparatus or to display the alphanumeric characters in the method. Additional preferred features are defined in the dependent claims.

Other aspects of the disclosed a data entry apparatus and method will become apparent from the following detailed description, the accompanying drawings and the appended claims.

### BRIEF DESCRIPTION OF THE DRAWINGS

Preferred embodiments of the invention are described below by way of example only with reference to FIGS. 1 to 5 of the accompanying drawings, wherein:

FIG. 1 is a schematic block diagram of a smart TV or similar system incorporating data entry apparatus in accordance with the present invention;

FIG. 2 is a diagrammatic representation of an Apple® remote control device 3 as used in the system of FIG. 1;

FIG. 3 is a diagrammatic representation of an alternative remote control device 3′ as used in the system of FIG. 1;

FIG. 4 is a screenshot of the screen when used to display the user interface of the system of FIG. 1 in accordance with the data entry apparatus and method of the present invention; and

FIG. 5 is a simplified flow diagram of the data entry method of the invention.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

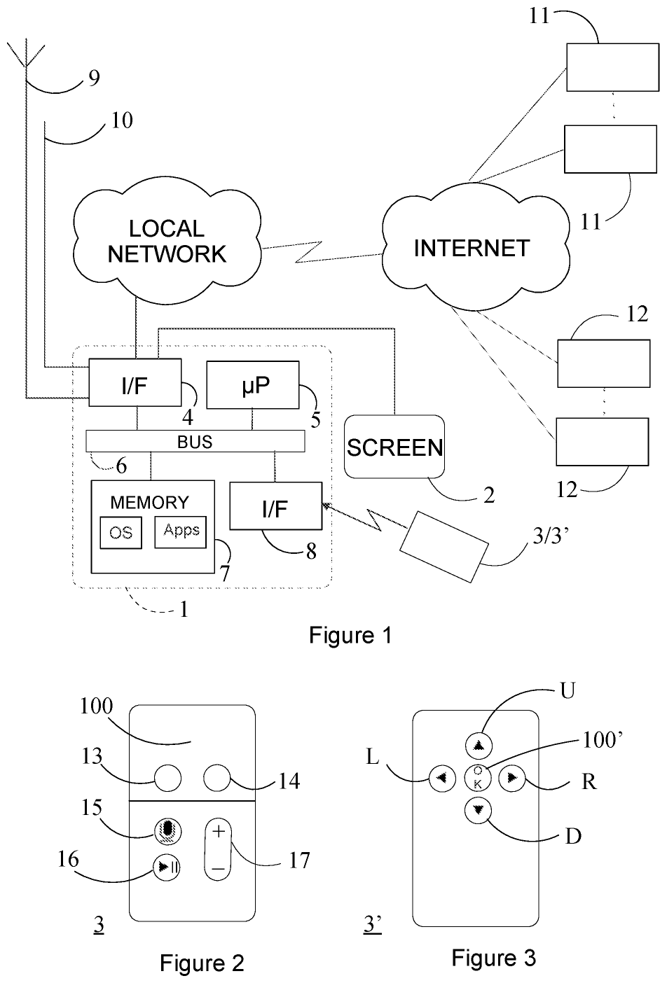

Referring to FIG. 1, the architecture of the system shown is generally similar to that shown in FIGS. 1 and 2 of the above-noted US 2012/246240A (Apple® Inc) to which reference is directed.

A smart TV 1 comprises a user interface block 8 which includes an infra-red receiver and decoder for receiving and decoding control signals from a local handheld remote control device 3/3′. The user interface block communicates via a bus 6 with a communications interface block 4, a microprocessor block 5 and a memory block 7.

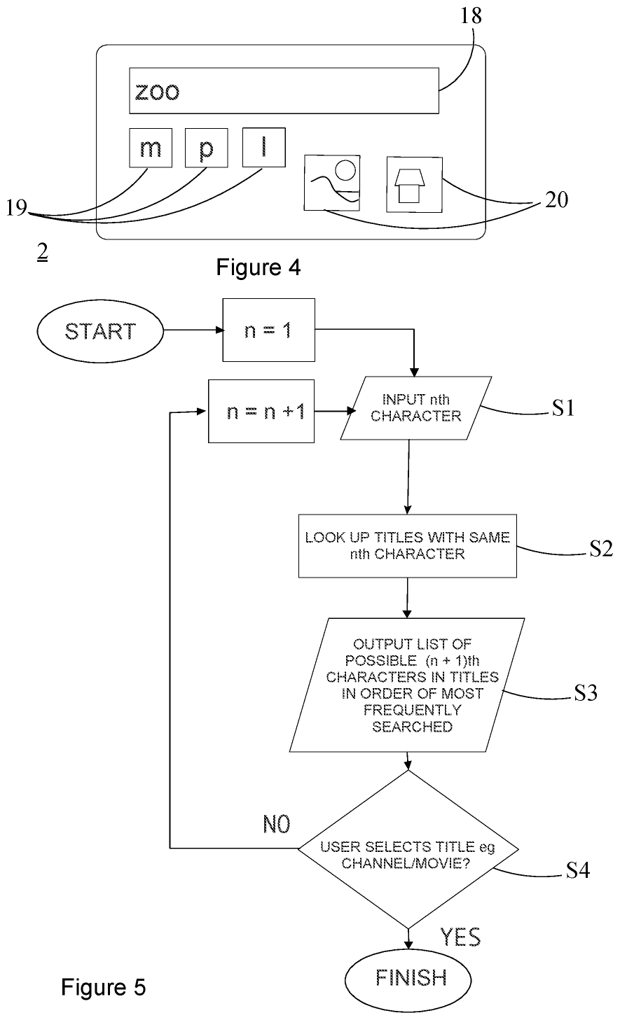

Communications interface block 4 includes inputs from a terrestrial or satellite TV aerial 9 and/or from a cable TV feed 10, as well as a WiFi connection to a LOCAL NETWORK which is connected to the INTERNET as shown, enabling internet access to remote content providers 11 and information provider sites 12. The remote content providers 11 may for example be servers (e.g. cloud servers) providing streaming video and/or audio viewable on smart TV 1. The information provider sites 12 may for example be websites having information about the content from providers 11, e.g. reviews, scheduling information, background information, discussions by other users and the like. Communications interface block 4 also includes a video output connection to a screen 2 on which the video and/or audio is displayed, as well as a user interface as shown in FIG. 4.

Microprocessor block 5 may include one or more processors arranged to execute instructions and process information needed for the smart TV to function, including instructions to display information as shown in FIG. 4 and to process input from the user via remote control 3/3′ as shown in FIG. 5. Memory block 7 includes one or more memories which may include volatile and non-volatile memory. The memories may include RAM, ROM, EPROM and also computer-readable media (e.g. disk media) such as a hard disk, DVD or CD-ROM for example. An operating system OS is stored in memory block 7, and also Apps (applications). The software used to implement the user interface of FIG. 4 and the data entry method of FIG. 5 is preferably part of the operating system OS but may additionally or alternatively be included as an App.

Referring now to FIG. 2, the remote control device 3 is a commercially available Apple® TV remote control including a menu button 13, a home button 14, a voice control (“Siri”) button 15, a play/pause button 16 and a volume up/down button 17. The upper portion 100 of the front surface of the device is a touchscreen area and can respond to touching and sliding in the same manner as an iPhone screen. Sliding on the touchscreen area 100 is used to navigate a linear array of alphanumeric characters (typically letters and numbers) displayed on screen 2 and touching is used to select from them in order to select e.g. TV channels or movies for viewing on screen 2. As described thus far, remote control device 3 is conventional and accordingly no further explanation of the above buttons is needed.

In the embodiment of FIG. 1, touchscreen area 100 of remote control device 3 is used to navigate a linear array comprising a reduced number of alphanumeric characters in accordance with FIGS. 4 and 5 as described below.

Another possible remote control device 3′ is shown in FIG. 3. This includes just four cursor movement keys, namely up arrow key U, down arrow key D, left arrow key L and right arrow key R, and a selection (“OK”) button 100′. The arrow keys are used to navigate along the array of alphanumeric characters shown in FIG. 4 and the selection button is used to select the character which has been located by the navigation.

When video and/or audio is being played, a pair of opposite arrow keys L and R or U and D can also be used to control the volume (e.g. L for decrease, R for increase) and selection button 100′ can be used as the pause/play button. Thus, remote control device 3′ fulfills many of the functions of remote control device 3.

Referring now to FIG. 4, a user who wishes to select a particular TV channel, remote content provider, movie or other video or audio stream makes an appropriate menu selection using the remote control device 3/3′ to instruct the display on screen 2 of a window 18 for entering successive characters of the name of the TV channel, remote content provider, movie or other video or audio stream (all of which are referred to below as titles).

In the screenshot shown in FIG. 4, the user has previously entered the characters z, o and o in succession and is now presented with the options m, p and 1 in respective cells 19 as shown, since the only titles beginning with “zoo” are “zoom”, “zoopla” and “zoology” and “zoological”. Unlike prior art methods, characters which do not appear as the next character in any title are not shown. Additionally, images 20 (only two of which are shown for the sake of simplicity) associated with the respective possible titles (in this case four images, corresponding to the titles “zoom”, “zoopla” and “zoology” and “zoological” respectively) are shown. Since “zoom” is the most commonly searched of the above titles, its character m is shown nearest the home position on the left of the screen, followed by p since “zoopla” is the next most commonly search title, and then 1 since “zoology” and “zoological” collectively are the least commonly searched titles.

At this point the user can either navigate to one of cells 19 using touchscreen area 100 of device 3 and touch the touchscreen area to select its character for addition to “zoo” in window 19 or he/she can select one of the images 20 to select the title directly. Selection of the title causes video and/or audio of that title to be displayed on screen 2. In this manner the remote control device 3 generates a control output for operating the smart TV 1. In a variant, remote control 3′ can be used to select an image 20 by navigating with the arrow keys L, R, U and D and selecting with the OK button 100′.

FIG. 5 shows the process in formal detail. At the START, the ordinal number n of the character to be entered is initialized at n=1. The user then inputs the first character (step S1) by navigating to and selecting one of e.g. the 26 letters of the alphabet (assuming there are respective titles beginning with all 26 letters) which will be displayed in boxes 19, using the remote control device 3/3′.

In step S2 the software looks up all titles beginning with the entered character and (step S3) displays a list of 2nd characters in the order that they are most frequently searched. The list is displayed in boxes 19 (FIG. 4) as described in the example above. A corresponding list of images 20 is also displayed as described above with reference to FIG. 4.

Then (step S4) the user possibly selects a title (e.g. a TV channel or a movie) e.g. by touching the area of touchscreen 100 corresponding to its associated image 20 and exits the YES branch of step 4 to the FINISH stage. However at this stage it is more likely that the user will choose to enter a third character, which involves exiting the NO branch of step 4, incrementing n from 2 to 3 (block n=n+1) and returning to step S1. In steps S2 and S3 a list of possible 3rd characters will be displayed in frequency order in boxes 19 (FIG. 4), in association with images 20. On selecting a desired third character and taking the NO exit of step S4, a situation similar to that shown in FIG. 4 (namely three entered characters) reached.

The user can go through further iterations of the flow diagram of FIG. 5 until sufficient characters have been entered to leave only a few possibilities for the title to be selected, at which stage a selection can be made by navigating to and selecting an image 20.

In some cases, numbers or other alphanumeric symbols may be included in the titles and displayed in the boxes 19. In a variant, the method and data entry apparatus described with reference to FIGS. 3, 4 and 5 can be used with a gaming console or a virtual reality headset for example.

Although various embodiments of the data entry apparatus and method have been shown and described, modifications may occur to those skilled in the art upon reading the specification. The present application includes such modifications and is limited only by the scope of the claims.

What is claimed is:

1. Data entry apparatus for selecting, as a control output, a string of N alphanumeric characters from a group of such strings, N being an integer of two or greater, the apparatus comprising:
a display arranged to display alphanumeric characters to a user; and
a selector, wherein the selector is operable by the user for selecting a displayed alphanumeric character, wherein the display is arranged to display n sets of user-selectable alphanumeric characters in succession (n being an integer of two or greater such that n≤N), an alphanumeric character of the nth set being selectable to obtain the alphanumeric character in the nth position of a string, the nth set omitting alphanumeric characters which are not present at the nth position of any of the strings in said group for at least some values of n.

2. The data entry apparatus according to claim 1, further comprising a memory, wherein said memory stores said group of strings of alphanumeric characters.

3. The data entry apparatus according to claim 1, wherein said strings of alphanumeric characters in said group comprise words appearing in a dictionary.

4. The data entry apparatus according to claim according to claim 1, wherein said display is arranged to display more commonly occurring alphanumeric characters in a manner which makes them more easily selectable by the user than less commonly occurring alphanumeric characters.

5. The data entry apparatus according to claim 4, wherein said display is arranged to display more commonly occurring alphanumeric characters closer to a home position of the screen.

6. The data entry apparatus according to claim 1, wherein said display is arranged to display an image associated with a sequence of two or more alphanumeric characters in response to the selection of a sequence of alphanumeric characters commonly associated with that image.

7. The data entry apparatus according to claim 1, wherein said selector comprises a pointing device.

8. The data entry apparatus according to claim 7, wherein said selector comprises one or more cursor-movement keys.

9. The data entry apparatus according to claim 7, wherein said display is arranged to display a linear array of alphanumeric characters and said selector is arranged to traverse said linear array to an alphanumeric character to be selected.

10. The data entry apparatus according to claim 1, wherein said selector comprises a wireless transmitter arranged to transmit a selection signal to a wireless receiver coupled to said display.

11. The data entry apparatus according to claim 10, wherein said selector is a remote control device arranged to select a video source for display.

12. The data entry apparatus according to claim 1, further comprising a video player or video receiver arranged to display video, wherein said control output selects a video stream to be played by said video player or received by said video receiver.

13. The data entry apparatus according to claim according to claim 1, wherein said data is a gaming apparatus, said gaming apparatus including a communications link to a remote gaming apparatus or server and further including a transmitter, wherein said transmitter transmits a control output signal over said communications link.

14. A computer implemented method of selecting a string of N alphanumeric characters from a group of such strings, N being an integer of two or greater, the method comprising:
displaying to a user n sets of alphanumeric characters in succession (n being an integer of two or greater such that n≤N); and
selecting a displayed alphanumeric character of each set, an alphanumeric character of the nth set being the alphanumeric character in the nth position of a string, wherein the nth set omits alphanumeric characters which are not present at the nth position of any of the strings in said group for at least some values of n.

15. A method according to claim 14 wherein said group of strings of alphanumeric characters is stored in a memory.

16. A method according to claim 14, wherein said strings of alphanumeric characters in said group comprise words appearing in a dictionary.

17. A method according to any of claim 14, wherein more commonly occurring alphanumeric characters are displayed in a manner which makes them more easily selectable by the user than less commonly occurring alphanumeric characters.

18. A method according to claim 17, wherein more commonly occurring alphanumeric characters are displayed closer than less commonly occurring alphanumeric characters to a home position of a display.

19. A method according to claim 14, wherein an image associated with a sequence of two or more alphanumeric characters is displayed in response to the selection of a sequence of alphanumeric characters commonly associated with that image.

20. A method according to claim 14, wherein a pointing device is used for selecting a displayed alphanumeric character.

21. A method according to claim 20, wherein selecting a displayed alphanumeric character comprises one or more cursor-movement keys.

22. A method according to claim 14, wherein a linear array of alphanumeric characters is displayed and selecting a displayed alphanumeric character traverses said linear array to an alphanumeric character to be selected.

23. A method according to any of claim 14, wherein selecting a displayed alphanumeric character includes transmitting a selection signal to a local wireless receiver by a wireless transmitter.

24. A method according to claim 23, wherein selecting a displayed alphanumeric character includes using a remote control device arranged to select a video source for display.

25. A method according to claim 14, wherein selecting a displayed alphanumeric character of each set includes generating a control output, wherein said control output selects a video stream to be played by a video player or received by a video receiver.

26. A method according to claim 14 further comprising transmitting a control output signal, wherein said control output signal is a gaming signal and is transmitted over a communications link.

27. A computer program product for selecting a string of N alphanumeric characters from a group of such strings, N being an integer of two or greater, wherein the computer program product comprises a computer-readable medium embodying program code means executable to:
display to a user n sets of alphanumeric characters in succession (n being an integer of two or greater such that n≤N); and
select a displayed alphanumeric character of each set, an alphanumeric character of the nth set being the alphanumeric character in the nth position of a string, wherein the nth set omits alphanumeric characters which are not present at the nth position of any of the strings in said group for at least some values of n.
